(19) United States
(12) Patent Application Publication
(10) Pub. No.: US 2008/0178424 A1
(43) Pub. Date: Jul. 31, 2008

(54) Locking Shoe Formed in Non-rotatable Halves for Curl Spring Window Balance System

(75) Inventor: Jeff Tuller, Rochester, NY (US)

Correspondence Address: BROWN & MICHAELS, PC;400 M & T BANK BUILDING, 118 NORTH TIOGA ST, ITHACA, NY, 14850, US

(73) Assignee: CALDWELL MANUFACTURING COMPANY, Rochester, NY (US)

(21) Appl. No.: 11/668,140

(22) Filed: Jan. 29, 2007

(51) Int. Cl. E05F 1/00

(52) U.S. Cl. 16/193

(57) ABSTRACT

A curl spring shoe cassette includes a mounting bracket mounted to interlock with connectors on top of a shoe body so that an uncurled length of the curl spring can be attached to the mount to hold the spring, the mount, and the shoe body together during shipment. Once the cassette is properly positioned within a shoe channel, it can be fastened to a back channel wall with screws so as to automatically disengage the mount from the shoe body, which can then support a counter balance sash.

### FIELD OF THE INVENTION

Counterbalance systems for vertically movable window sash.

### BACKGROUND

This invention improves on a locking shoe and mounting bracket usable with a curl spring window balance system such as explained in U.S. Pat. Nos. 5,353,548, and 5,463,793. The invention adds convenience and reliability to the proposals of those patents.

### SUMMARY

The improvements made by this invention include a mounting bracket that can hold its position while being shipped with a shoe cassette holding a curl spring and yet can automatically disengage from the spring shoe when fastened to a sash jamb channel. The shoe cassettes are also preferably formed of identical halves that are unhanded so that a shoe cassette can be deployed on either side of a window sash. The cassette halves are preferably configured to resist relative rotation as they are splayed apart in response to cam action of a tilt lock cam contained within the shoe. The tilt lock cams can be configured to retain headed sash pins, or can have recesses or slots that allow a sash pin to extend more than half way through a locking cam. The improved system also allows locking pads to be inexpensively installed on the shoes to exert increased locking friction when a sash tilts and shoe cams lock the shoes in their channels.

### DRAWINGS

FIG. 1 is an isometric view of a shoe cassette including a curl spring, a spring mount, and a sash pin to counter balance one side of a window sash.

FIG. 2 is an isometric view of a shoe cassette, including a curl spring, a spring mount, and optional locking pads to counter balance an opposite side of a window sash.

FIG. 3 is a fragmentary view of an upper region of the cassette of FIG. 2 omitting a curl spring to help illustrate a preferred configuration of shoe mount.

FIG. 4 is a fragmentary cross-sectional top view of the shoe cassette of FIG. 2 partially mounted within a shoe channel of a window jamb to illustrate how the shoe mount (in solid black) clears a tilt latch of a sash.

FIG. 5 is a fragmentary rear view of the mounting bracket and the top of the shoe cassette of FIG. 2 to illustrate how the mounting bracket mounts on the shoe body.

FIG. 6 is an exploded isometric view of the cassette of FIG. 2 showing a curl spring, locking cam, and shoe halves, without a spring mount.

FIG. 7 is an exploded isometric view reversed from the view of FIG. 6 to show that each shoe half includes a rotation resisting projection and recess, and also showing a tilt lock cam with a through channel that can receive a sash pin extending more than half-way through the cam.

### DETAILED DESCRIPTION

Shoe cartridges or cassettes 10, such as illustrated in FIGS. 1, 2, 6 and 7, include shoe bodies 11 that contain curl springs 30 and locking cams 20. Shoe bodies 11 are preferably molded in halves 11a and 11b that are identical and that fit together in an interlock allowing a lower region of the shoe bodies to expand or splay apart in response to rotation of locking cam 20. Shoe body halves 11a and 11b are preferably interconnected at their upper regions by a pair of headed rails or ridges that are formed on each of the body halves to slide into an interconnect with the opposite body half.

An upper edge or top region 12 of shoe body 11 supports mounting bracket 50. A short length of curl spring 30 is uncurled from shoe body 11 and is attached to mounting bracket 50, which can hold the assembled shoe body 11, curl spring 30, and mounting bracket 50 together for assembly into a window or shipment to a window manufacturer.

Mounting bracket 50 improves on a simpler bracket suggested in the '548 and '793 patents. Bracket 50 is robust enough, and well enough braced and interlocked at the top 12 of shoe body 11, to hold itself and curl spring 30 in place in an assembled cassette 10 during shipment. This provides the convenience to a window manufacturer of shoe cassettes arriving assembled with mounting bracket 50 ready to secure each cartridge in a shoe channel of a window jamb. All that is necessary is to slide each cassette into a shoe channel to the mount position, and then drive in one or two fastening screws 51 to fasten mount 50 in place. Two fasteners or mounting screws 51 are preferred so that mount 50 can resist a torque or turning force applied by curl spring 30. In some jamb channels, mount 50 can be blocked from rotation by channel walls, making a single mounting screw 51 all that is necessary for securely holding mount 50 in place.

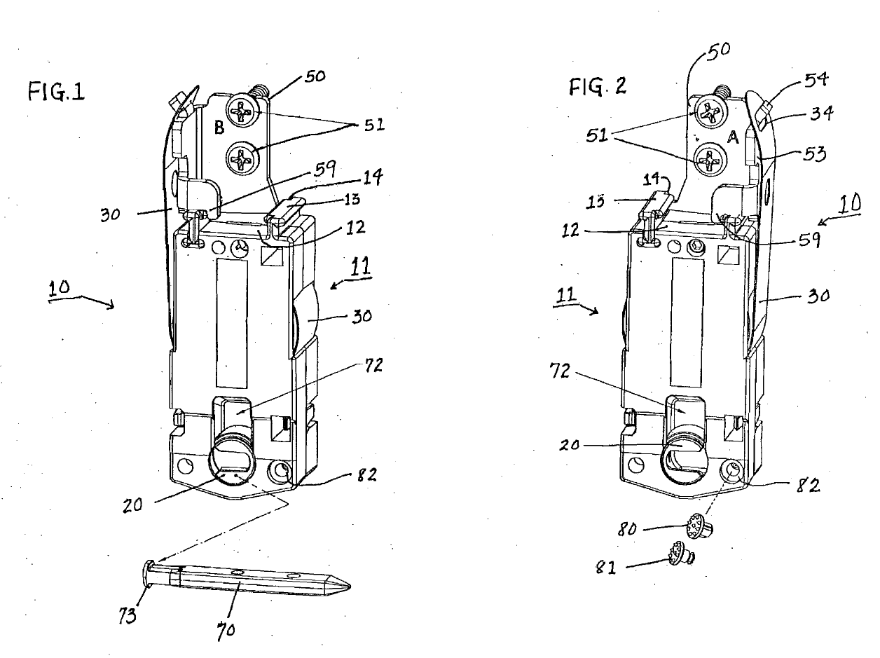

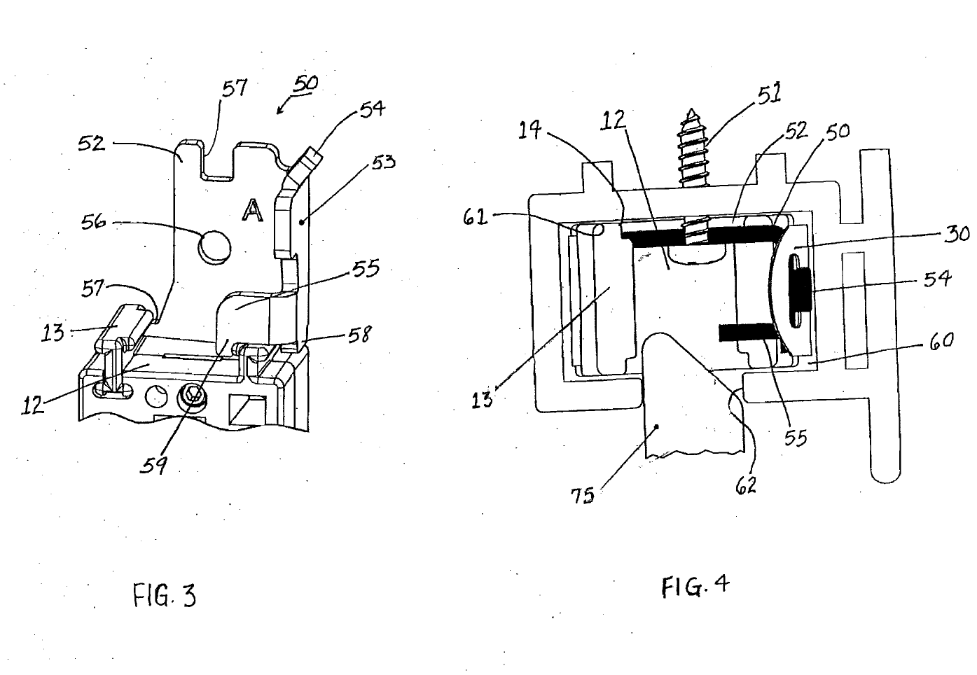

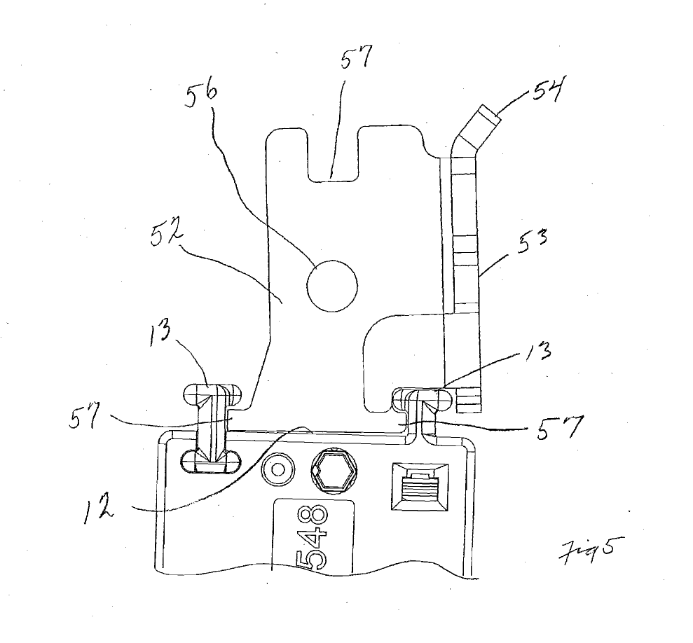

To accomplish its improvements, mounting bracket 50 preferably includes mounting wall 52, spring holding wall 53, and brace 55, as best shown in FIGS. 3, 4 and 5. Mounting wall 52 is preferably flat so that it can be fastened snuggly against back wall 61 of shoe channel 60. Mounting wall 52 also includes a hole 56 or a hole 56 and a slot 57 to receive one or two mounting screws 51. Spring holding wall 53 includes a projection 54 oriented to fit into an opening 34 in curl spring 30, which exerts a downward pull on mounting bracket 50 to hold spring 30, mount 50, and body 11 in the assembled position illustrated in FIGS. 1 and 2. Spring connecting wall 53 is preferably normal or perpendicular to mounting wall 52, and brace 55 preferably extends normal or perpendicular to spring holding wall 53 and parallel with mounting wall 55. The interrelationship between walls 52 and 53 and brace 55 cooperates with the downward bias of spring 30, to securely support mount 50 on the top 12 of shoe body 11.

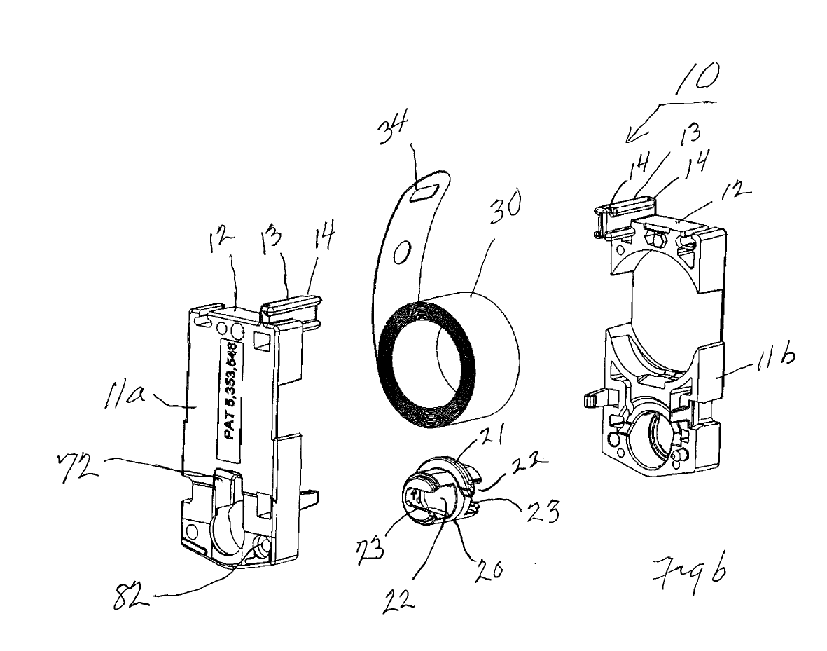

The top or upper surface 12 of shoe body halves 11a and b preferably include headed ridge or “dog bone” shaped connectors 13 that hold shoe body halves 11a and b together in proper alignment. Connectors 13 also allow a superposed attachment of an additional curl spring container mounted on top of shoe body 11. The headed rail connectors also provide a sturdy interlock with mount 50, as shown in FIG. 5.

Mounting wall 52 preferably has an opposed pair of projections 57 that extend under headed connectors 13 to prevent mount 50 from pivoting out of its position on the top 12 of body 11. The projection 57 that is farthest from spring holding wall 53 is especially well positioned to prevent this. Spring holding wall 53 has a downwardly extending projection 58 that overlaps with the adjacent dog bone connector 13. Brace 55 rests on top of a connector 13, and has a projection 59 (FIGS. 1-3) that hooks over an edge of the connector 13 on which it rests. All these features ensure that mount 50 stays reliably in place on top of shoe body 11, especially when curl spring 30 provides a downward force pulling mount 50 downward against the top of shoe body 11.

Headed rail connectors 13 have end notches 14 that allow mount projections 57 to escape from under connectors 13 when mounting wall 52 is fully attached flat against back wall 61 of shoe channel 60. In the position of mounting bracket 50 as illustrated in FIG. 4, mounting screw 51 has not been tightened enough to draw mounting bracket 50 snugly against back wall 61 of shoe channel 60 so that mounting bracket 50 has not yet escaped from shoe body 11 via notches 14 in the ends of connector rails 13. Tightening screw 51 beyond the position illustrated in FIG. 4 to draw mounting wall 52 snugly against panel wall 61 then moves projections 57 into notches 14 of connectors 13, which allows mount 50 to escape or separate from the top 12 of shoe body 11. In practice, this separation occurs when shoe body 11 is pulled downward after mount 50 is fully secured within channel 60. In effect, the sturdy interlock between mount 50 and shoe body 11 that allows shipment of assembled cassettes as illustrated in FIGS. 1 and 2 also automatically disconnects mount 50 from cassette body 11 when mount 50 is fully secured in place in a shoe channel 60.

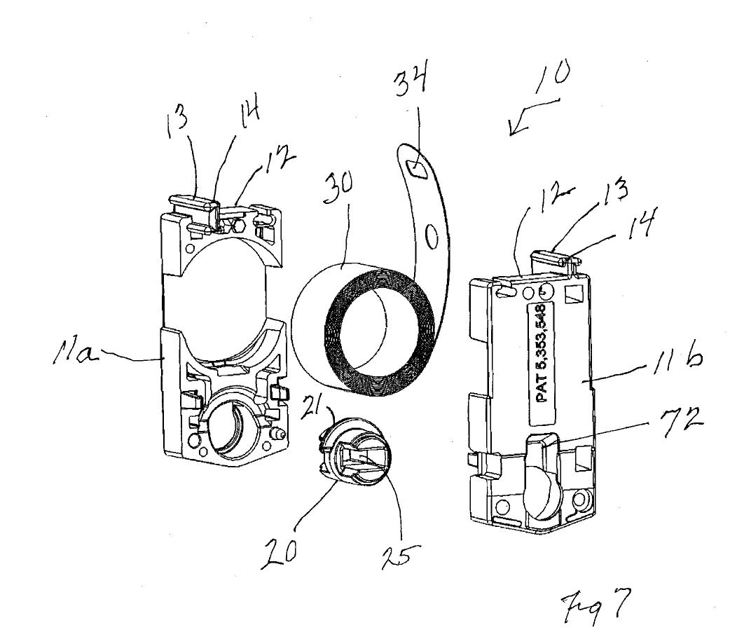

Since mount 50 is preferably free to slide along top surface of shoe body 11 when fastened into a shoe channel, as described, it is desirable to allow relative movement between curl spring 30 and spring holding projection 54. Relative movement at the interconnection between spring 30 and projection 54 allows mount 50 to slide into mounted position without pulling spring 30 laterally out of its alignment with shoe body 11. A preferred way of accomplishing such relative movement is to make hole 34 in spring 30 an oval or oblong hole or slot, as best shown in FIGS. 6 and 7. Projection 54 can then move laterally within oblong hole or slot 34 to leave spring 30 in its aligned position relative to body 11 while mount 50 slides laterally into a released position engaging wall 61 of a shoe channel.

As best shown in FIG. 6, locking cam 20 preferably has sash pin channels or slots 22 arranged on opposite sides of an annular cam 21. Each of the cam slots 22 preferably has in turned walls 23 that can capture a head 73 of a sash pin 70 (illustrated in FIG. 1). It is also possible, and is preferred in some situations, for locking cam 20 to have a through recess or channel 25 that allows a sash pin to extend more than half way into locking cam 20 (shown in FIG. 7). A through channel 25 in cam 20 allows a sash pin to penetrate deeply into cam 20 and is preferred to increase the wind resistance of a sash.

Each body part 11a and b preferably has a recess 72 formed above the end regions of cam 20. When a sash supported by cassettes 10 is tilted out of the window plane, cam 20 turns to a locking position that aligns its channel 25 or slots 22 with recesses 72. This allows the heads 73 of sash pin 70 to be raised upward from cam slots 22 or channel 25 and into recesses 72 to facilitate removing a tilted sash from a window.

Recesses 72 also facilitate replacing a removed sash, because recesses 72 allow extra room above cam 20 to receive sash pin 70 that can then be dropped down into cam slots 22 or 25. Recesses 72 also provide a somewhat larger area for maneuvering sash pins 70 into shoe bodies 11a and b before dropping downward into cam channels 25 or slots 22. The sash pins 70 can have heads 73 that interlock with cam edges 23 to prevent withdrawal of sash pin 70 from shoe cassettes 10 if a window is carried in a suitcase fashion before installation. Sash pins 70 can also be un-headed and long enough to extend deeply into cam 20 for improved wind resistance of a sash. The described arrangement of cam channels 22 and 25, recesses 72, and sash pins 70 also allows shoes 11 to be unhanded, so that any shoe can be installed on either side of a sash to be counterbalanced.

Mounting brackets 50, to the contrary, are preferably handed so that each bracket is arranged to be mounted on only one side of a sash. This preference is to assure that mounting brackets 50 do not interfere with tilt latches of a counter balanced sash. FIG. 4 illustrates one way that this can be accomplished. Tilt latch 75, which is typically spring loaded to be snapped into latching engagement with channel slot 62 when a tilted sash is moved back to an upright position, runs in slot 62 of channel 60 where it moves up and down with sash 50 to prevent accidental tilting. When latches 75 are moved inward against their spring bias, they allow deliberate tilting of a counter balanced sash.

Brace 55 of mounting bracket 50 is preferably mounted in an orientation that clears tilt latch 75 so that mounting bracket 50 does not interfere with vertical movement of tilt latch 75 past mount 50. The left- and right-handedness of mounting bracket 50 as identified by the A and B markings appearing on brackets 50 in FIGS. 1 and 2 ensures that a mounting bracket on each side of a window sash clears the tilt latch 75.

Lower corners of body parts 11a and b preferably have molded recesses 82 that can receive locking pads 80 or 81 to increase a frictional locking effect when a balanced sash tilts to pivot cam 20 to a locking position. Locking pads 80 and 81 (schematically shown in FIG. 2) are alternatives that can be pressed into a recess 82 to achieve a pressed fit in recess 82 for locking pad 80 or a snap fit in recess 82 for locking pad 81. Pads 80 and 81 can be surfaced with different materials and given different surface configurations to increase the frictional security of a shoe lock achieved by pivoting of cam 20 to spread shoe bodies 11a and b somewhat apart within channel 60.

When locking cam 20 pivots with a tilted sash, its cam surface 21 slides in between lower edges of shoe bodies 11a and b to splay the shoe bodies apart and lock the shoe cassette in place in a jamb channel. This splaying apart of the lower regions of shoe bodies 11a and b also produces a force that tends to rotate the shoe bodies relative to each other as they are forced apart by cam surface 21. Such rotation would tend to diminish the splaying apart of the shoe body halves, and this tendency is overcome by projections 15 and corresponding recesses 16 that are formed in the lower region of each shoe half. As bodies 11a and b splay apart in response to rotation of cam surface 21, projections 15 remain engaged with recesses 16 to prevent any relative rotation between shoe halves 11a and 11b. Recesses 16 can be formed as inward facing parts of recesses 82 whose outward facing parts can receive locking pads 80 or 81. Projections 15 and recesses 16 are also preferably alternately formed on each body half 11a and b so that these halves remain identical to each other while providing a pair of mating recesses 16 and projections 15.

What is claimed is:

1. In a window sash counterbalance system including a curl spring disposed with curled convolutions in a shoe divided between shoe halves that can splay apart to lock within a shoe channel in response to rotation of a tilt lock cam, the improvement comprising:
a lower region of the halves of the shoe are interconnected by projections extending from one of the halves into recesses in another of the halves;
the projections and recesses are arranged to stay engaged with each other while the shoe halves splay apart to prevent relative rotation between the shoe halves in response to pivoting of the tilt lock cam; and
the projections and recesses extend in the direction that the shoe halves move when splayed apart.

2. The system of claim 1 wherein each shoe half is identical and each shoe half has a projection and a recess engageable respectively with a corresponding recess and projection in the other shoe half.

3. The system of claim 1 wherein the shoe halves each retain friction pads enhancing a frictional locking of the shoe halves in a shoe channel in response to pivoting of the tilt cam.

4. The system of claim 1 wherein each of the shoe halves has a pin recess disposed above a pin receiving channel in the tilt lock cam so that a sash pin can be maneuvered into the recess and then move from the recess into the cam channel.

5. The system of claim 4 wherein the cam channel extends through the cam to allow a sash pin to extend more than half way through the shoe.

6. The system of claim 1 wherein the cam channel is configured to retain a headed pin.

7. The system of claim 1 wherein the shoes are unhanded and are deployable on either right or left sides of a sash.

8. A sash shoe formed of a pair of shoe halves that are interconnected to contain a curl spring and a tilt lock cam, the sash shoe comprising:
an upper region of the shoe halves being permanently connected, and a lower region of the shoe halves being splayed by rotation of the tilt lock cam;
a lower region of the shoe halves including a projection extending from one of the shoe halves into a recess in the other shoe half;
the projection having a sliding fit in the recess as the shoe halves splay apart; and
the projection maintaining engagement with the recess while the shoe halves splay apart in response to the tilt lock cam so that the inter-engagement between the projection and the recess prevents the shoe halves from rotating relative to each other in response to the tilt lock cam.

9. The sash shoe of claim 2 wherein each of the shoe halves includes a projection and a recess arranged so that each projection has a sliding engagement with a recess as the shoe halves splay apart.

10. The sash shoe of claim 2 wherein the shoe halves are identical and are molded of resin material.

11. The sash shoe of claim 2 wherein the shoe halves contain friction pads arranged to engage shoe channel walls to increase a shoe locking effect when the shoe halves splay apart.

12. The sash shoe of claim 2 wherein the tilt lock cam has a recess configured to hold a headed sash pin.

13. The sash shoe of claim 2 wherein the tilt lock cam has a channel allowing a sash pin to extend more than half way through the shoe.

14. A tilt lock shoe formed of a pair of molded resin halves connected together in an upper region to contain a curl spring and a tilt lock cam, the shoe comprising:
lower regions of the shoe engaging a cam surface of the tilt lock cam that splays the lower halves of the shoe apart when the cam tilts;
tilting of the cam also produces a force tending to rotate the shoe halves relative to each other; and
a lower region of the shoe halves including a projection on one of the shoe halves having a sliding fit in a recess in the other shoe half to prevent the relative rotation as the shoe halves splay apart.

15. The sash shoe of claim 14 wherein the shoe halves are identical.

16. The sash shoe of claim 14 wherein the shoe halves support friction pads enhancing locking of the shoes when the tilt lock cam tilts.

17. The sash shoe of claim 14 wherein each of the shoe halves has a pin recess arranged above a channel in the tilt lock cam.

18. The sash shoe of claim 14 wherein the tilt lock cam has a through channel allowing a sash pin to extend more than half way through the shoe.

19. The sash shoe of claim 14 wherein the tilt lock cam has a channel that retains the head of a headed sash pin.
